(19) United States
(12) Patent Application Publication
(10) Pub. No.: US 2026/0322314 A1
(43) Pub. Date: Oct. 15, 2026

(54) CLIP HOLDER ASSEMBLY FOR INSTALLING PHOTOVOLTAIC TILES

(71) Applicant: Arka Energy Inc., Allen, TX (US)

(72) Inventors: Giriprasad Vadla, Bengaluru (IN); Praveen Kumar D, Bengaluru (IN); Apheth D Almeida, Bengaluru (IN)

(73) Assignee: Arka Energy Inc., Allen, TX (US)

(21) Appl. No.: 19/177,809

(22) Filed: Apr. 14, 2025

(51) Int. Cl. H02S 20/23; H02S 20/25

(52) U.S. Cl. CPC H02S 20/23; H02S 20/25

(57) ABSTRACT

Disclosed is a clip holder assembly for installing photovoltaic tiles over a rail system. The clip holder assembly comprises: a clip holder having a first surface (FS) and a second surface (SS), wherein the FS has a groove with a projecting lip, and the SS has a pattern that engages with a surface of a photovoltaic tile to be installed; a snap clip arranged within the groove; and stopper elements configured to be inserted into ends of the clip holder to secure the snap clip, wherein when the clip holder assembly is in use, the photovoltaic tile is installed by engaging the snap clip with a groove of the rail system, thereby providing a detachable locking engagement therebetween for securing the photovoltaic tile, wherein the rail system is attached to a roof fixture.

### TECHNICAL FIELD

The present disclosure relates to clip holder assemblies for installing photovoltaic tiles over rail systems.

### BACKGROUND

An increasing demand for solar energy systems has led to widespread adoption of photovoltaic tiles as a sustainable and aesthetically-pleasing alternative for generating electricity. However, a rooftop installation of the photovoltaic tiles involves considerable challenges, for example, in terms of a high installation time, a high installation cost, a high technical complexity of an installation process, and the like. Proper alignment and secure mounting of the photovoltaic tiles are essential to ensure a high efficiency and durability of the rooftop installation.

However, existing methods for installing photovoltaic tiles are associated with several drawbacks. Firstly, some existing methods often rely on mechanical fasteners, for example, such as screws, bolts, nuts, and the like, for installing photovoltaic tiles. Such mechanical fasteners are prone to improper alignment or over-tightening, which can compromise a structural integrity of the photovoltaic tiles, and often fail to offer necessary load-bearing capacity and durability under extreme weather conditions. Moreover, maintenance and repair processes upon photovoltaic tile installation also become highly complicated, as replacing individual photovoltaic tiles requires partial or complete dismantling of adjacent components. Furthermore, employment of the mechanical fasteners depends on intricate manual processes and increasing overall complexity and cost of installation.

Therefore, in the light of the foregoing discussion, there exists a need to overcome the aforementioned drawbacks.

### SUMMARY

The aim of the present disclosure is to provide a clip holder assembly that allows for a reliable, secure and stable mounting of photovoltaic tiles over a rail system without needing any fasteners. This reduces an installation time and improves an ease of maintenance and overall structural integrity and durability of the photovoltaic tiles under varying environmental conditions. The aim of the present disclosure is achieved by a clip holder assembly for installing photovoltaic tiles over a rail system, as defined in the appended independent claims to which reference is made to. Advantageous features are set out in the appended dependent claims.

In an aspect, an embodiment of the present disclosure provides a clip holder assembly for installing photovoltaic tiles over a rail system, the clip holder assembly comprising:
a clip holder having a first surface and a second surface, wherein the first surface has a groove with a projecting lip, and the second surface has a pattern that engages with a surface of a photovoltaic tile to be installed;
a snap clip arranged within the groove of the clip holder; and
a pair of stopper elements configured to be inserted into ends of the clip holder to secure the snap clip within the groove of the clip holder,
wherein when the clip holder assembly is in use, the photovoltaic tile is installed by engaging the snap clip with a groove of the rail system, thereby providing a detachable locking engagement therebetween for securing the photovoltaic tile, wherein the rail system is attached to a roof fixture.

The present disclosure provides the aforementioned clip holder assembly that allows for a reliable, secure and stable mounting of photovoltaic tiles over the rail system without needing any mechanical fasteners. This reduces an installation time and improves an ease of maintenance and overall structural integrity and durability of the photovoltaic tiles under varying environmental conditions. An inclusion of the snap clip ensures a secure locking engagement with the rail system, while the stopper elements prevent an excessive movement or compression of the snap clip. Such a synergistic combination of the snap clip and the stopper elements in the clip holder of the clip holder assembly allows for installing the photovoltaic tiles over the rail system without needing any mechanical fasteners. The clip holder assembly is susceptible to withstand thermal and mechanical stresses, and effectively functions under varying environmental conditions. Beneficially, the groove with the projecting lip of the clip holder prevents downward sliding of the photovoltaic tile, ensuring a firm attachment even under adverse conditions such as vibrations, wind uplift, or impacts. A design of the clip holder assembly is compatible with various roof fixtures and the rail systems, making it suitable for diverse installation environments. Moreover, the pattern on the second surface of the clip holder enhances friction with the photovoltaic tile, ensuring compatibility with tiles of different materials, sizes, and designs. The detachable locking engagement allows for easy removal and reinstallation of the photovoltaic tile, facilitating repairs or upgrades without damage to the assembly or adjacent tiles.

Throughout the description and claims of this specification, the words "comprise", "include", "have", and "contain" and variations of these words, for example "comprising" and "comprises", mean "including but not limited to", and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1A is a schematic illustration of a clip holder assembly for installing photovoltaic tiles over a rail system, while FIG. 1B is a detailed view of said clip holder assembly, in accordance with an embodiment of the present disclosure;

FIG. 2A is a perspective view of a clip holder of a clip holder assembly, FIG. 2B is a perspective view of a snap clip of the clip holder assembly, FIG. 2C is a perspective view of a stopper element of the clip holder assembly, while FIG. 2D is a perspective view of an entirety of the clip holder assembly, in accordance with an embodiment of the present disclosure; and

FIG. 3 illustrates an exemplary scenario where a plurality of clip holder assemblies is in use, in accordance with an embodiment of the present disclosure.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

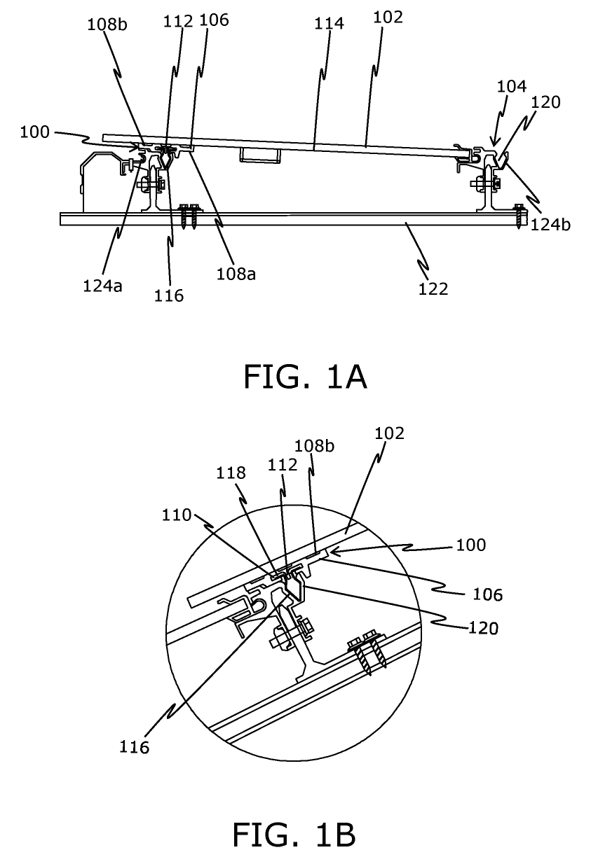

Referring to FIGS. 1A and 1B, FIG. 1A is a schematic illustration of a clip holder assembly 100 for installing photovoltaic tiles 102 over a rail system 104, while FIG. 1B is a detailed view of said clip holder assembly 100, in accordance with an embodiment of the present disclosure.

With reference to FIGS. 1A and 1B, the clip holder assembly 100 comprises: a clip holder 106 having a first surface 108a and a second surface 108b, wherein the first surface 108a has a groove 110 with a projecting lip 112, and the second surface 108b has a pattern 126 that engages with a surface 114 of a photovoltaic tile 102 to be installed; a snap clip 116 arranged within the groove 110 of the clip holder 106; and a pair of stopper elements 118 configured to be inserted into ends of the clip holder 106 to secure the snap clip 116 within the groove 110 of the clip holder 106, wherein when the clip holder assembly 100 is in use, the photovoltaic tile 102 is installed by engaging the snap clip 116 with a groove 120 of the rail system 104, thereby providing a detachable locking engagement therebetween for securing the photovoltaic tile 102, wherein the rail system 104 is attached to a roof fixture 122.

FIGS. 1A and 1B are merely examples, which should not unduly limit the scope of the claims herein. A person skilled in the art will recognize many variations, alternatives, and modifications of embodiments of the present disclosure.

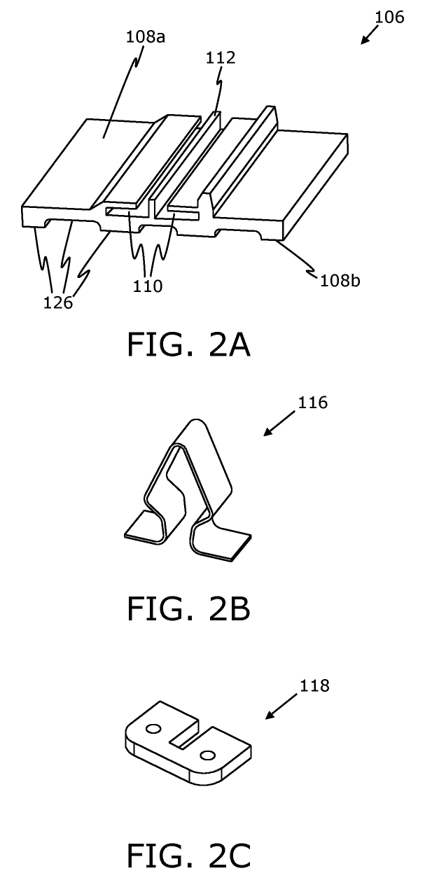

Referring to FIGS. 2A, 2B, 2C and 2D, FIG. 2A illustrates a schematic illustration of the clip holder 106 of the clip holder assembly 100 (as shown FIG. 1A), FIG. 2B illustrates a perspective view of the snap clip 116 (as shown in FIG. 1A), FIG. 2C illustrates a perspective view of the stopper element 118 (as shown in FIG. 1A), while FIG. 2D illustrates a perspective view of the clip holder assembly 100 (as shown in FIG. 1A).

With reference to FIG. 2A, the clip holder 106 is shown to have the first surface 108a and the second surface 108b, wherein the first surface 108a has the groove 110 with the projecting lip 112, and the second surface 108b has the pattern 126 that engages with the surface 114 of the photovoltaic tile 102 to be installed. Herein, the pattern 126 on the second surface 108b of the clip holder 106 is a textured pattern 126 to increase friction between the clip holder assembly 100 and the photovoltaic tile 102.

With reference to FIG. 2B, there is shown a perspective view of the snap clip 116. The snap clip 116 is of an omega shape. The omega shape of the snap clip 116 facilitates a snap-fit mechanism that locks into place when engaged with the groove of the rail system.

With reference to FIG. 2C, there is shown a perspective view of a stopper element 118. The stopper element 118 includes a precisely cut slot, which facilitates secure attachment of the stopper element 118 with the clip holder.

With reference to FIG. 2D, there is shown a perspective view of the clip holder assembly 100, the clip holder assembly 100 comprises the clip holder 106 having the first surface 108a and the second surface 108b, wherein the first surface 108a has the groove 110 with the projecting lip 112, and the second surface 108b has the pattern 126 that engages with a surface 114 of the photovoltaic tile 102 to be installed. Moreover, the clip holder assembly 100 comprises the snap clip 116. Furthermore, the clip holder assembly 100 comprises the pair of stopper elements 118 configured to be inserted into ends of the clip holder 106 to secure the snap clip 116 within the groove 110 of the clip holder 106.

FIGS. 2A, 2B, 2C and 2D are merely examples, which should not unduly limit the scope of the claims herein. A person skilled in the art will recognize many variations, alternatives, and modifications of embodiments of the present disclosure.

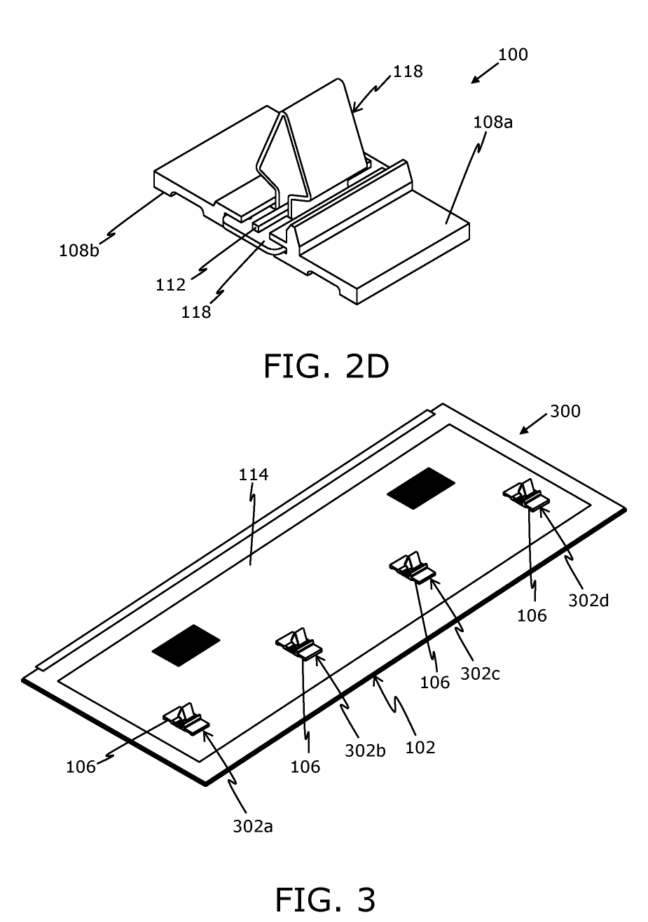

With reference to FIG. 3, there is shown an exemplary implementation 300 of a plurality of clip holder assemblies 302a, 302b, 302c and 302d. As shown, the second surface of the clip holder 106 of the respective clip holder assemblies 302a-d has the pattern 126 that engages with the surface 114 is attached on the photovoltaic tile 102 to be installed. Moreover, when the plurality of clip holder assemblies 302a-d is in use, the photovoltaic tile 102 is installed by engaging the respective snap clips of the clip holder assemblies 302a-d with respective grooves (not shown) of the rail system 104, thereby providing a detachable locking engagement therebetween for securing the photovoltaic tile 102, wherein the rail system 104 is attached to a roof fixture (not shown).

FIG. 3 is merely an example, which should not unduly limit the scope of the claims herein. A person skilled in the art will recognize many variations, alternatives, and modifications of embodiments of the present disclosure.

Throughout the present disclosure, the term "clip holder assembly" refers to an integrated structural unit that is designed to facilitate secure and detachable installation of photovoltaic tiles (such as the photovoltaic tile 102, for sake of simplicity and clarity) onto the rail system 104. The clip holder assembly 100 enables reliable and efficient attachment of the photovoltaic tiles 102 because the clip holder assembly does not need traditional mechanical fasteners for the attachment. The term "photovoltaic tile" refers to a structural and functional roofing element that integrates solar cells into its design, enabling it to generate electricity from sunlight while serving as a protective covering for a building's roof. Typically, the photovoltaic tiles 102 are made of durable materials (for example, such as tempered glass, polymers, composites, and similar) designed to withstand environmental stresses such as ultra-violet (UV) radiation, thermal expansion, and mechanical loads.

Optionally, the clip holder assembly 100 is compatible with photovoltaic tiles 102 of at least one: varying shapes, varying shapes sizes, varying shapes designs. In this regard, the clip holder assembly 100 can accommodate photovoltaic tiles 102 with different shapes, such as rectangular, square, hexagonal or curved edges. Moreover, the clip holder assembly 100 supports photovoltaic tiles 102 of different dimensions, whether larger or smaller in width, length or thickness. Furthermore, the clip holder assembly 100 can work with photovoltaic tiles 102 that has distinct aesthetic or functional features, such as textured surfaces, bevelled edges, or the photovoltaic tiles 102 with integrated wiring or connectors. Such a compatibility is achieved through a design of the clip holder assembly 100 which allows for adjusting or firmly gripping the photovoltaic tiles 102 with varying specifications. It will be appreciated that the compatibility of the clip holder assembly 100 with the photovoltaic tiles 102 allows the clip holder assembly 100 to be used across different solar panel models, reducing a need for custom mounting solutions for each photovoltaic tile type. It will also be appreciated that since the clip holder assembly 100 is susceptible to be employed with various shapes, sizes, and designs of the photovoltaic tiles 102 the clip holder assembly 100 can be understood to be versatile and appealing to manufacturers and installers dealing with photovoltaic technologies. A technical effect of having the compatibility of the clip holder assembly 100 with the photovoltaic tiles 102 is to make the clip holder assembly 100 suitable for global markets, where different photovoltaic tile configurations are prevalent. Additionally, the installers can quickly mount the photovoltaic tiles 102 of various shapes and sizes without requiring significant adjustments or multiple components. Solar panel manufacturers can maintain a lower inventory of the clip holder assembly 100 due to their broad compatibility, reducing overall supply chain complexity.

Throughout the present disclosure, the term "rail system" refers to a structural framework that is designed to support the photovoltaic tiles 102 during installation and operation. Typically, the rail system 104 consists of elongated, parallel rails that are attached to a roof fixture or another additional supporting surface. Beneficially, the rails of the rail system 104 serve as a primary mounting structure, providing both alignment and stability for the photovoltaic tiles 102. Notably, the clip holder assembly 100 offers a fastener-free installation system that simplifies and accelerates a mounting process of the photovoltaic tiles 102 while ensuring stability, load-bearing capacity, and ease of maintenance. Moreover, the clip holder assembly 100 beneficially eliminates a need for screws, bolts, or adhesives, thereby reducing installation time and complexity involved in a roof-top installation of the photovoltaic tiles 102. The clip holder assembly 100 accommodates thermal expansion and uses materials resistant to corrosion, fire, and weather-related degradation, ensuring long-term durability.

Optionally, the rail system 104 includes a top row rail 124a and a bottom row rail, and the clip holder assembly 100 is configured to engage with both the top row rail 124a and the bottom row rail to provide additional stability. In this regard, the term "row rail" refers to a horizontal element of the rail system 104 that provides support and a mounting surface for the photovoltaic tiles 102 or panels. It is designed to allow the photovoltaic tiles 102 to be securely attached and positioned on a roof or other surface. The top row rail 124a engages a tile channel of one photovoltaic tile 102. The bottom raw rail 124b engages with the snap clip 114 of the clip holder assembly 100 connected with another photovoltaic tile 102 that is adjacent to the one photovoltaic tile. Moreover, the clip holder assembly 100 provides a detachable locking engagement with both the top row rail 124a and the bottom row rail 124b, ensuring that the photovoltaic tile 102 is firmly held at both its edges. Moreover, by utilizing both the top row rail 124a and bottom row rail 124b, the rail system 104 ensures that the photovoltaic tiles 102 are not only mounted securely but also protected from displacement or shifting under environmental forces such as wind, weather, or mechanical stress. A technical effect of including the top row rail 124a and the bottom row rail 124b in the rail system 104 is that the engagement of both rails ensures that the mechanical stresses, such as wind uplift, downward pressure, or thermal expansion, are evenly distributed across the photovoltaic tiles 102 and the rail system 104. This prevents localized stress and prolongs a lifespan of components of the clip holder assembly 100. Additionally, a secure mounting reduces a risk of the photovoltaic tiles 102 coming loose, enhancing a safety of the installation for residential, commercial, or industrial environments.

Throughout the present disclosure, the term "clip holder" refers to a structural component that is designed to facilitate secure and fastener-free attachment of the photovoltaic tiles 102 to the rail system. Typically, the clip holder 106 that serves as an intermediary between the photovoltaic tile and the rail system 104. The term "surface" refers to an exterior or outermost plane of the clip holder 106 that interacts with other components or the photovoltaic tile. In this regard, the first surface 108a is a surface of the clip holder 106 that faces the rail system 104. The second surface 108b is a surface of the clip holder 106 that interfaces with a surface 114 of the photovoltaic tile 102. The term "grooves" refers to a recessed or an indented channel formed along the first surface 108a of the clip holder 106. Typically, the groove 108 is designed to serve as a slot or guide for interfacing with the snap clip 116 (as discussed later in detail). The groove 108 is dimensioned to accommodate the snap clip 116 securely while maintaining flexibility for easy installation and removal of the snap clip 116 without compromising stability. The term "projecting lip" refers to an elevated or protruding edge of the clip holder 106 that extends outward from the groove 108 on the first surface 108a of the clip holder 106. The projecting lip 110 is integrated along the edge of the groove 108, ensuring an overall stability of the clip holder assembly 100.

Optionally, the projecting lip 112 of the groove 110 on the first surface 108a of the clip holder 106 prevents a downward sliding of the photovoltaic tile when installed. In this regard, a primary purpose of the projecting lip 112 is to ensure a stability and secure placement of the photovoltaic tiles 102. The projecting lip 112 achieves this by acting as a barrier that maintains a position of the photovoltaic tile, especially under gravitational loads or operational loads. Once the photovoltaic tile is engaged with the clip holder assembly 100, the projecting lip 112 interacts with an edge or underside of the photovoltaic tile to resist a downward movement. This prevents the photovoltaic tile from slipping out of the clip holder assembly 100 due to external forces. A technical effect of having the projecting lip 112 to prevent the downward sliding of the photovoltaic tiles 102 that reduces the risk of accidents or damage during operation. Additionally, the projecting lip 112 provides a passive, mechanical solution for securing the photovoltaic tile 102, eliminating a need for additional fasteners or components. This simplifies installation and reduces the likelihood of errors during assembly.

Throughout the present disclosure, the term "pattern" refers to a design made up on the second surface 108b of the clip holder 106. Typically, the pattern 126 may include ridges, textured surfaces, or other structural designs to improve a mechanical interaction with the surface 114 of the photovoltaic tile 102. The pattern 126 on the second surface 108bof the clip holder 106 increases friction and provides an enhanced grip between the clip holder 106 and the surface 114 of the photovoltaic tile 102. This ensures that photovoltaic tile 102 remains firmly secured to the clip holder 106 even under environmental stresses such as wind or vibration. The surface 114 of the photovoltaic tile 102 is a surface of the photovoltaic tile 102 that comes into physical contact with the patterned second surface 108b of the clip holder 106 during installation.

Optionally, the pattern 126 on the second surface 108b of the clip holder 106 is a textured pattern 126 to increase a friction between the clip holder assembly 100 and the photovoltaic tile 102. In this regard, the term "textured pattern" refers to a designed surface modification or arrangement of geometric features on the second surface 108b of the clip holder 106. The textured pattern 126 is intended to enhance a grip between the clip holder assembly 100 and the photovoltaic tile 102. This is due to the fact that a roughness of the textured pattern 126 enhances a coefficient of friction between the second surface 108b of clip holder assembly 100 and a contacting surface of the photovoltaic tile 102, thereby improving the grip between the clip holder 106 and the photovoltaic tile 102. The textured pattern 126 can take various forms, such as linear ridges, cross-hatched grooves, embossments, dimples, or other raised or recessed shapes. It will be appreciated that the textured pattern 126 on the second surface 108b reduces a need for additional fasteners or adhesives, thereby simplifying the installation process. A technical effect of the textured pattern 126 is to prevent sliding or slipping of the photovoltaic tile 102 from the clip holder assembly 100 during installation or under any external forces such as wind or vibrations. By preventing sliding or movement of the photovoltaic tile 102, a likelihood of wear, tear, or damage to the photovoltaic tile 102 is reduced.

Throughout the present disclosure, the term "snap clip" refers to a fastening component designed to fit securely within the groove 110 of the clip holder 106. The snap clip 116 serves as the primary locking mechanism that provides a detachable and robust connection between the clip holder 106 and the rail system 104 used for installing photovoltaic tiles 102. The snap clip 116 is dimensioned to fit snugly within the groove 110 on the first surface 108a of the clip holder 106, ensuring proper alignment and secure attachment. It is to be noted that the snap clip 116 is free moving inside the groove 110, prior to fastening. The snap clip 116 engages with the rail system 104 to provide a secure yet detachable locking engagement for the photovoltaic tile 102 installation. It is to be noted that the snap clip 116 can be of an omega shape. The omega shape of the snap clip 116 facilitates a snap-fit mechanism that locks into place when engaged with the groove 120 of the rail system 104. The omega shape provides a robust and secure engagement while maintaining an ability to detach when necessary. A rounded profile of the omega shape effectively distributes forces across surface of the snap clip 116 and minimizes stress concentration points. The flexibility of the snap clip 116 allows it to snap into place when sufficient pressure is applied, creating a firm connection. It will be appreciated that the snap clip 116 provides a snap-fit design that eliminates the need for complex tools or adhesives. It will also be appreciated that the snap clip 116 allows for repeated engagement and disengagement without loss of functionality.

Optionally, the snap clip 116 is made up of a material selected for its durability and resistance to different environmental conditions. In this regard, the material for the snap clip 116 is selected based on its physical, chemical, and mechanical properties. This ensures that the snap clip 116 can perform reliably under various environmental and operational conditions. The different environmental conditions can, for example, be high wind loads and high snow loads. It will be appreciated that the snap clip 116 is manufactured from one or more materials that are well-known for their durability and resistance. Examples of such materials include, but are not limited to high-grade metals (for example, such as stainless steel, aluminium alloys, titanium, and similar), weather-resistant plastics (for example, such as polyamide (nylon), PEEK (Polyether ether ketone), and fiberglass-reinforced plastics. Moreover, the snap clip 116 is made up of a material that can be a combination of metals and polymers for improved performance characteristics. A technical effect of selecting the material for its durability and resistance to the different environmental conditions is to ensures that the snap clip 116 maintains its functional properties in extreme heat, cold, moisture, snow and UV exposure. Such a reliability is vital for outdoor photovoltaic installations that are exposed to the different environmental conditions, such as heat, snow, and rain continuously. Additionally, the durable and resistant material reduces wear and tear, requiring less frequent maintenance or replacement, thereby contributing a photovoltaic tile installation system that is cost-effective and user-friendly.

Optionally, the snap clip 116 is coated with a corrosion-resistant material to enhance its longevity in outdoor environments. In this regard, the term "corrosion-resistant material" refers to a substance or a coating that is applied to a surface of the snap clip 116 that prevents or significantly reduces a rate of corrosion when exposed to environmental factors (for example, such as moisture, oxygen, salts, chemicals, or similar). The corrosion-resistant material functions by forming a protective barrier that isolates the underlying substrate from corrosive agents or by chemically stabilizing the surface of the snap clip 116 to resist oxidation or other degradation processes. Examples of the corrosion-resistant material may include, but are not limited to, metallic coatings (such as zinc or anodized aluminium), polymeric coatings (such as powder coatings or epoxy-based finishes), chemical treatments (such as phosphate or chromate conversion coatings), and natural or synthetic paints with anti-corrosive properties. Techniques for coating any element with the corrosion-resistant material are well-known in the art.

Optionally, the snap clip 116 is designed to withstand at least one of: (i) an uplift pressure lying in a range of 2500 Pascals (Pa) to 3500 Pa, (ii) a downward pressure lying in a range of 4000 Pa to 5000 Pa. In this regard, the term "uplift pressure" refers to an upward force exerted on the snap clip 116 by environmental factors, for example, such as wind load and snow loading conditions. The uplift pressure describes a stress applied in an opposite direction of the gravity, which could potentially lift or detach the photovoltaic tile 102 from the rail system 104. It can be understood that the uplift pressure lying in the range of 2500 Pa to 3500 Pa is a permissible uplift pressure that the snap clip 116 can resist while maintaining its secure engagement with the groove 120 of the rail system 104. Optionally, the uplift pressure lies in the range of 2500, 2600, 2700, 2800, 2900, 3000, 3100, 3200, 3300 or 3400 Pa up to 2600, 2700, 2800, 2900, 3000, 3100, 3200, 3300, 3400 or 3500 Pa. A technical effect of withstanding the uplift pressure lying in the range of 2500 Pa to 3500 Pa is to mitigate risks of photovoltaic tile 102 detachment due to wind uplift or snow loading conditions, enhancing overall installation safety. This makes installation of the photovoltaic tiles 102 adaptable to various environmental conditions, including regions with high wind speeds or heavy snowfall. The term "downward pressure" refers to a force exerted on the snap clip 116 in the direction of gravity. The force may result from at least one of: a weight of the photovoltaic tile 102, snow accumulation, an additional load pressing down on the snap clip 116. It can be understood that the downward pressure lying in the range of 4000 Pa to 5000 Pa is a permissible downward pressure that the snap clip 116 can endure without deforming, cracking, or losing its engagement with the groove 120 of the rail system 104. Optionally, the downward pressure lies in the range of 4000, 4100, 4200, 4300, 4400, 4500, 4600, 4700, 4800 or 4900 Pascals up to 4100, 4200, 4300, 4400, 4500, 4600, 4700, 4800, 4900 or 5000 Pascals. A technical effect of withstanding the downward pressure in the range of 4000 Pa to 5000 Pa is to ensure that the snap clip 116 can withstand the weight of the tile and external downward forces like snow or other environmental loads, ensuring the tile remains securely installed. Additionally, the snap clip 116 remains securely engaged with the rail system 104, ensuring the photovoltaic tile 102 is firmly attached even under extreme weather conditions and making it suitable for widespread deployment in diverse climatic regions while maintaining safety and structural integrity.

Optionally, the snap clip 116 is configured to provide an audible indication to confirm a secured locking of the photovoltaic tile 102 with the rail system 104. In this regard, the term "audible indication" refers to a distinct sound generated when the snap clip 116 securely locks into the rail system 104 during installation of the photovoltaic tile 102. This sound serves as a feedback mechanism to inform an installer (for example, such a photovoltaic installation personnel) that the snap clip 116 has properly engaged with the rail system 104. The audible sound may include for example, such as a "click" sound, a "snap" sound, or a similar recognizable sound that is easily heard in a typical snap lock. The audible indication is generated through the interaction of the snap clip 116 with the rail system 104. It will be appreciated that installers can work faster and more confidently when they receive immediate confirmation of proper locking, thereby improving the overall efficiency of the installation process. The audible indication reduces a likelihood of improper installation by eliminating guesswork during the installation process. A technical effect of providing the audible indication is to minimize a need for visual confirmation or additional verification steps that results in saving time and reducing human error. Additionally, the audible indication ensures usability even in low-visibility conditions, such as dim lighting or difficult installation angles, making the clip holder assembly 100 versatile and user-friendly.

Throughout the present disclosure, the term "stopper elements" refers to structural components that act as physical barriers or securing mechanisms. The pair of stopper elements 118 are designed to interface with the ends of the clip holder 106 to constrain the snap clip's 116 movement within the groove 110. The pair of stopper elements 118 prevents unintended displacement, sliding or compression of the snap clip 116 along the groove 110, which could compromise the locking mechanism. The pair of stopper elements 118 are shaped and sized to fit snugly into the ends of the clip holder 106. Moreover, the pair of stopper elements 118 are configured to be physically inserted into the open ends of the clip holder 106. It will be appreciated that the pair of stopper elements 118 are made of a material that is resistant to thermal expansion and contraction, in order to maintain secure engagement under varying environmental conditions. The pair of stopper elements 118 are designed to absorb vibrations and reduce stress on the snap clip 116 during high wind conditions. Typically, the pair of stopper elements 118 are made of durable materials such as aluminium, stainless steel, galvanized steel, nylon, polycarbonate (PC), acrylonitrile butadiene styrene (ABS), fiber-reinforced plastics (FRP), and similar. A design of the pair of stopper elements 118 complements with designs of the clip holder 106 and snap clip 116, thereby providing a robust and reliable mechanism for securing the photovoltaic tiles 102. It will also be appreciated that the pair of stopper elements 118 helps to reduce wear and tear on the snap clip 116 and groove surfaces, enhancing the clip holder assembly's 100 longevity.

Optionally, the stopper elements 118 of said pair are configured to prevent excessive sliding and compression of the snap clip 116 within the groove 110 of the clip holder 106. In this regard, the stopper elements 118 of said pair ensures that the snap clip 116 remains securely in position, maintaining its intended functionality and engagement with the rail system 104. It will be appreciated that the stopper elements 118, by preventing excessive sliding and compression of the snap clip 116, improves the overall stability and reliability of the clip holder assembly 100 during installation and operation. The stopper elements 118 ensure that the snap clip 116 cannot slide beyond a predefined range within the groove 110. A technical effect of preventing excessive sliding and compression of the snap clip 116 within the groove 110 of the clip holder 106 is to maintain proper positioning of the snap clip 116 during the installation process, minimizing the risk of errors. By maintaining the structural integrity of the snap clip 116, the stopper elements 118 ensure that the photovoltaic tiles 102 remain securely installed even under varying environmental stresses.

Optionally, the clip holder 106 and said pair of stopper elements 118 are attached together using an adhesive. In this regard, the term "adhesive" refers to a substance or a material that is used to bond the clip holder 106 and the said pair of stopper elements 118 together securely. Typically, the adhesive is selected based on its ability to create a strong, durable, and lasting connection under various environmental conditions. Examples of the adhesive include, but are not limited to, a polyurethane (PU) 126 adhesive, a silicone adhesive, an acrylic adhesive, a hot-melt adhesive, and a cyanoacrylate adhesive. It will be appreciated that adhesive bonding provides a cost-effective method for assembly the clip holder 106 and said pair of stopper elements 118 together, resulting into low material and labour costs as compared to mechanical fasteners in case of prior art. This makes the clip holder assembly 100 more affordable for a large-scale deployment. The adhesive is applied to either or both surfaces of the clip holder 106 and the stopper elements 118, where the stopper elements 118 and the clip holder 106 come into contact with each other. Once the adhesive is applied, the stopper elements 118 are positioned at the ends of the clip holder 106 and left to cure, forming a strong bond. This ensures that the stopper elements 118 stay firmly in place, preventing any movement or displacement of the snap clip 116 within the groove 110, thus securing the photovoltaic tile 102 during installation. A technical effect of using the adhesive is that it ensures the stopper elements 118 stay securely in place over time, even under various environmental conditions, which is critical for maintaining the integrity of the snap clip 116 and preventing excessive sliding or compression.

Optionally, the clip holder assembly 100 is designed to meet fire safety standards for rooftop installations by using fire-resistant materials for the clip holder 106 and the snap clip 116. In this regard, the term "fire-resistant materials" refers to substances that resist ignition, limit a spread of fire, and withstand high temperatures without losing their structural or functional integrity. The fire-resistant materials ensure that the clip holder 106 and the snap clip 116 comply with established fire safety standards for the rooftop installations. It will be appreciated that the fire-resistant materials do not ignite easily and are capable of withstanding exposure to fire or extreme heat for a prolonged duration. For example, the fire-resistant material may include, but are not limited to, ceramic-based composites, metal alloys, fire-retardant polymers, glass-reinforced polymers, and similar. The fire-resistant materials are selected for their high melting points, low flame spread properties, and ability to retain structural integrity under heat. The fire-resistant materials reduce the likelihood of fire spreading, thereby safeguarding the rooftop, the building, and its occupants. A use of fire-resistant materials ensures adherence to safety standards and certifications required for rooftop systems in various jurisdictions. A technical effect of using fire-resistant materials for the clip holder 106 and snap clip 116 is to ensure that it prevents ignition and limit fire propagation, reducing fire hazards associated with photovoltaic tiles 102 on the rooftops. Meeting fire safety standards facilitates smoother approvals for rooftop installations, making the assembly more marketable and reliable.

Throughout the present disclosure, the term "detachable locking engagement" refers to a secure connection between the snap clip 116 of the clip holder assembly 100 and the groove 120 of the rail system 104 that can be established and disengaged as needed. The detachable locking engagement creates sufficient resistance to mechanical forces, such as the uplift pressure or the downward pressure, commonly encountered in the rooftop installations. It is noteworthy that despite providing a strong and stable connection between the snap clip 116 of the clip holder assembly 100 and the groove 120 of the rail system 104, the locking mechanism is designed to be detachable, allowing for easy removal of the photovoltaic tile 102 for maintenance, replacement, or system modifications without causing damage to the rail system 104 or tile. It will be appreciated that the detachable locking engagement enables assembly and disassembly using minimal tools or force, supporting an efficient and straightforward installation process. The detachable locking engagement ensures precise alignment of the photovoltaic tile 102 with the rail system 104, contributing to a uniform and aesthetically pleasing layout of the photovoltaic tiles 102. It will also be appreciated that the photovoltaic tile 102 can be independently removed from or installed to the rail system 104 without disturbing adjacent photovoltaic tiles 102. Thus, the clip holder assembly 100 allows for a quick and tool-free installation (or removal) of the photovoltaic tile 102 onto the rail system 104. The term "roof fixture" refers to structural elements of a roof that provide the foundational support for attaching the rail system 104 used in photovoltaic tile 102 installations. Typically, the roof fixture 122 includes any part of the roof structure, such as, beams, rafters, trusses, and similar, capable of supporting the load of the photovoltaic tiles 102. The roof fixture 122 serves as the base to which the rail system 104 is securely fastened, ensuring that the photovoltaic tiles 102 remain anchored to the roof under various conditions. The rail system 104 is secured to the roof fixture 122, such as hooks, clamps, mounts, and similar. The roof fixture 122 can vary depending on the type of roof, such as pitched roofs, flat roofs, metal roofs, and similar and may include specialized mounts, clamps, or brackets designed for specific roofing materials. It will be appreciated that the roof fixture 122 helps distribute the load of the photovoltaic tiles 102 evenly across the roof structure.

Optionally, the groove 110 of the clip holder 106 is dimensioned to allow for a thermal expansion of the snap clip 114 without compromising the detachable locking engagement of the snap clip 116 with the groove 120 of the rail system 104. In this regard, the term "thermal expansion" refers to a physical phenomenon where the snap clip 116 increases in size or volume due to an increase in temperature. Typically, materials expand when heated as their molecules move more vigorously, causing the material to occupy more space. The snap clip 116 is made of the material that may undergo dimensional changes when exposed to the varying environmental temperatures. To account for this, the groove 110 of the clip holder 106 is designed with specific dimensions that allow the snap clip 116 to expand and contract without losing its detachable locking mechanism with the groove 120 of the rail system 104. A technical effect of dimensioning the grove of the clip holder 106 to allow for the thermal expansion of the snap clip 116 is that it ensures that the clip holder assembly 100 remains functional and intact across a wide range of temperatures and the photovoltaic tiles 102 stay securely attached to the rail system 104.

What is claimed is:

1. A clip holder assembly for installing photovoltaic tiles over a rail system, the clip holder assembly comprising:
a clip holder having a first surface and a second surface, wherein the first surface has a groove with a projecting lip, and the second surface has a pattern that engages with a surface of a photovoltaic tile to be installed;
a snap clip arranged within the groove of the clip holder; and
a pair of stopper elements configured to be inserted into ends of the clip holder to secure the snap clip within the groove of the clip holder,
wherein when the clip holder assembly is in use, the photovoltaic tile is installed by engaging the snap clip with a groove of the rail system, thereby providing a detachable locking engagement therebetween for securing the photovoltaic tile, wherein the rail system is attached to a roof fixture.

2. The clip holder assembly of claim 1, wherein the snap clip is made up of a material selected for its durability and resistance to different environmental conditions.

3. The clip holder assembly of claim 1, wherein the snap clip is designed to withstand at least one of: (i) an uplift pressure lying in a range of 2500 Pascals (Pa) to 3500 Pa, (ii) a downward pressure lying in a range of 4000 Pa to 5000 Pa.

4. The clip holder assembly of claim 1, wherein the projecting lip of the groove on the first surface of the clip holder prevents a downward sliding of the photovoltaic tile when installed.

5. The clip holder assembly of claim 1, wherein the pattern on the second surface of the clip holder is a textured pattern to increase a friction between the clip holder assembly and the photovoltaic tile.

6. The clip holder assembly of claim 1, wherein the stopper elements of said pair are configured to prevent excessive sliding and compression of the snap clip within the groove of the clip holder.

7. The clip holder assembly of claim 1, wherein the groove of the clip holder is dimensioned to allow for a thermal expansion of the snap clip without compromising the detachable locking engagement of the snap clip with the groove of the rail system.

8. The clip holder assembly of claim 1, wherein the rail system includes a top row rail and a bottom row rail, and the clip holder assembly is configured to engage with both the top row rail and the bottom row rail to provide additional stability.

9. The clip holder assembly of claim 1, wherein the snap clip is configured to provide an audible indication to confirm a secured locking of the photovoltaic tile with the rail system.

10. The clip holder assembly of claim 1, wherein the clip holder assembly is designed to meet fire safety standards for rooftop installations by using fire-resistant materials for the clip holder and the snap clip.

11. The clip holder assembly of claim 1, where the clip holder assembly is compatible with photovoltaic tiles of at least one: varying shapes, varying shapes sizes, varying shapes designs.

12. The clip holder assembly of claim 1, wherein the snap clip is coated with a corrosion-resistant material to enhance its longevity in outdoor environments.

13. The clip holder assembly of claim 1, wherein the clip holder and said pair of stopper elements are attached together using an adhesive.
